(19) United States
(12) Patent Application Publication
(10) Pub. No.: US 2010/0058082 A1
(43) Pub. Date: Mar. 4, 2010

(54) MAINTAINING NETWORK LINK DURING SUSPEND STATE

(75) Inventors: Howard Jeffrey Locker, Cary, NC (US); David Carroll Challener, Raleigh, NC (US); Justin Tyler Dubs, Durham, NC (US); Steven Richard Perrin, Raleigh, NC (US); Michael Terrell Vanover, Raleigh, NC (US); Jennifer Greenwood Zawacki, Hillsborough, NC (US)

Correspondence Address: ROGITZ & ASSOCIATES, 750 B STREET, SUITE 3120, SAN DIEGO, CA, 92101, US

(73) Assignee: Lenovo (Singapore) Ple., Ltd.

(21) Appl. No.: 12/198,979

(22) Filed: Aug. 27, 2008

(51) Int. Cl. G06F 1/32

(52) U.S. Cl. 713/320

(57) ABSTRACT

A low power processor in a computer is kept energized in a suspend state in which a main processor of the computer is deenergized. The low power processor maintains a network connection by sending keepalive packets as required by the network communication protocol.

### FIELD OF THE INVENTION

The present invention relates generally to maintaining a network connection during a computer's suspend state.

### BACKGROUND OF THE INVENTION

To save energy and battery life, computers such as notebook computers may enter a suspend state after a period of inactivity, in which only memory is energized so that state information is preserved but most other components, including the processor, are powered down. Unfortunately, because maintaining a network connection typically requires communication activity such as the transmission of so-called “keepalive” packets, network connectivity can be lost during the suspend state. Reestablishing such connections upon such time as the user wishes to resume network communication consumes time.

### SUMMARY OF THE INVENTION

A portable computer includes a portable housing and a main processor in the housing that is configured to use a main network communication stack to communicate with a network in a normal operating mode. A low power processor also is in the housing and is configured to use a low power network communication stack to communicate with the network in a suspend mode.

In some embodiments network communication is controlled by the main processor using the main network communication stack in the normal operating mode and is controlled by the low power processor using the low power network communication stack in the suspend mode. In non-limiting implementations information may be exchanged between the stacks prior to deenergizing the main processor.

The information exchanged between the stacks may include information needed to send keepalive packets to the network to maintain a network connection. In some implementations the information exchanged between the stacks includes information that renders unique message payloads between the computer and the network. The information may be exchanged by means of storing the information in a location accessible to both processors, or by giving at least one processor capability to read the stack of the other processor, or in response to a change of network communication state. In specific embodiments the information can include a secret key and rolling header information.

In another aspect, a computer has a main processor with associated main network communication protocol stack configured to communicate with a network as well as a low power processor with associated low power network communication protocol stack configured to communicate with the network.

In another aspect, a method includes maintaining a low power processor in a computer energized in a suspend state, deenergizing a main processor of the computer in the suspend state, and using the low power processor to maintain a network connection by sending keepalive packets as required by a network communication protocol.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a non-limiting block diagram of an example system in accordance with present principles; and

FIG. 2 is a non-limiting flow chart showing example logic that can be used in accordance with present principles.

### DETAILED DESCRIPTION OF THE PREFERRED EMBODIMENT

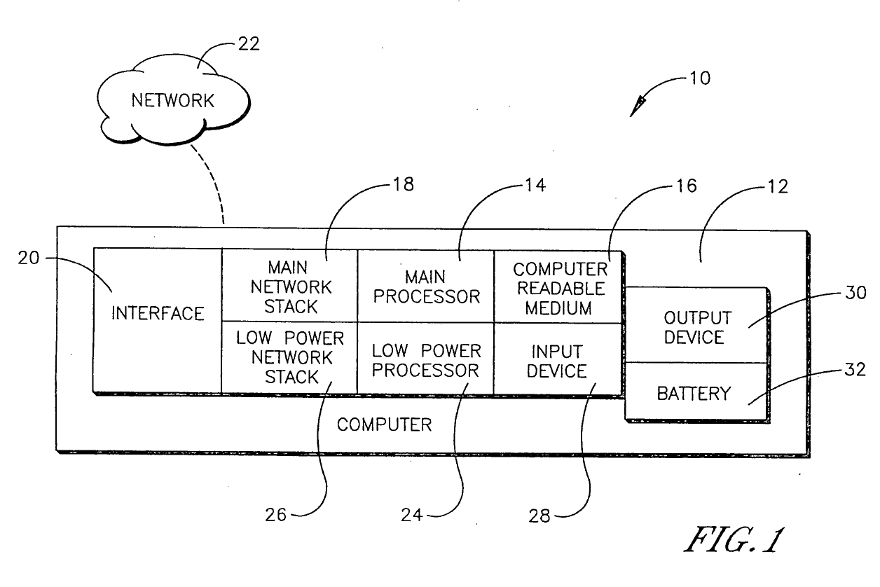

Referring initially to FIG. 1, a portable computer 10 such as, e.g., a personal digital assistant (PDA) or notebook computer or laptop computer includes a portable hand-held housing 12 holding a main processor 14 and tangible computer readable storage medium 16 such as but not limited to disk storage, solid state storage, etc. The storage medium 16 can bear data, as well as logic executable by the main processor 14 pursuant to logic set forth herein.

Among other things, the main processor 14 can execute a main network communication protocol stack 18 to communicate using a network communication interface 20 such as a wired or wireless modem or telephony transceiver with a network 22 such as the Internet and/or a virtual private network (VPN) on the Internet. Without limitation, the main protocol stack 18 can include, from top to bottom, an application layer, a transport layer, a network layer, and a link layer, any or all of which may be encrypted. Without limitation, the interface 20 can be a Bluetooth interface, a WiFi interface, a global system for mobile communication (GSM) transceiver, code division multiple access (CDMA) transceiver or variant such as wideband-CDMA, a TDMA or FDMA or SDMA transceiver, an orthogonal frequency division multiplexing (OFDM) transceiver, etc.

The computer 10 can also include a low power processor 24 that can execute a low power network communication protocol stack 26 to communicate using the network communication interface 20. The stacks 18, 26 mirror each other.

The processors may receive input from a user input device 28 such as a keypad and/or mouse and/or joystick, etc. and may provide output to an output device 30 such as a computer monitor and/or printer and/or audio speaker. The above components may be powered by one or more rechargeable direct current batteries 32.

In a suspend mode, which may be entered when, for example, no user input has occurred for a predetermined period, battery power is conserved by maintaining only the low power processor 24 energized along with memory that maintains state information, including network connection information. The following table lists non-limiting state information that may be preserved:

```
Virtual Private Network (VPN) State Information
  Internet Protocol (IP) Security (IPSec) VPNs
      Internet Key Exchange (IKE) Parameters
            Pre-shared key or certificate
            Endpoint identification
            Local and Remote networks/hosts
            Tunnel/transport mode
            Remote gateway
            Main/aggressive mode
            IPsec protocol (Encapsulating Security Payload (ESP)/
            Authentication
      Header (AH)/both)
            IKE encryption
            IKE authentication
            IKE Diffie-Helman (DH) group
            IKE lifetime
            Perfect Forward Secrecy (PFS) on/off/identities
            IPsec DH group
            IPsec encryption (Advanced Encryption Standard (AES),
            Data Encryption
      Standard (DES), key length)
            IPsec authentication
            IPsec lifetime
        Session Association Parameters
            session association number
            session keys
            initialization vectors
  Secure Sockets Layer (SSL) VPNs
      “TO DO” list
Transport Communication Protocol (TCP) State Information
      Connection State
      Source Port
      Destination Port
      Sequence Number
      Acknowledgement Number
      Window Size
IP State Information
      Source Address
      Destination Address
```

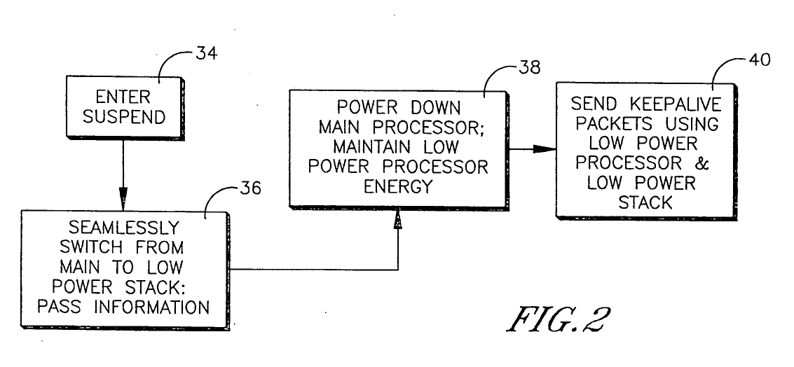

FIG. 2 shows non-limiting logic that may be employed by the computer 10 of FIG. 1. At block 34, a low power state, referred to herein as a “suspend” state, is entered. In one non-limiting embodiment the suspend state is entered after the elapse of a predetermined period of no user input.

Moving to block 36, when the suspend state is entered and prior to powering down the main processor 14 pursuant thereto, network communication is seamlessly switched from the main stack 18 to the low power stack 26, and, hence, network communication control is switched from the main processor 14 to the low power processor 24. Information pertaining to network state, and in particular information needed to send “keepalive” packets to the network to maintain the network connection, is exchanged between the stacks, it being understood that such exchange may be ongoing during normal operation so that when the suspend mode is entered, no further information need be exchanged. Without limitation, all or some of the above-listed information may be exchanged.

It is to be understood that the information exchange may be effected in various non-limiting ways. As one example, the information may be stored in a location such as the medium 16 that is accessible to both processors 14, 24. Or, one or both processors 14, 24 may be given the capability to read the network stack of the other processor. Yet again, upon a change of network state the stacks 18, 26 may exchange information with each other to maintain synchronization.

Still focusing on information that can be exchanged between the stacks 18, 26 for greater illustration, as understood herein IPSec may be used to maintain connectivity between a VPN and the computer 10 using Internet Control Message Protocol (ICMP) pings, a form of a keepalive packet. ICMP pings re encrypted using ESP and AH, with ESP using AES, DES, 3DES, etc. encryption. Accordingly, the attendant protocol and secret key may be shared between the stacks 18, 26. Further, recognizing that AH uses a secret rolling header sequence to prevent “man in the middle” attacks, the rolling header information may also be shared between the stacks. In general, information that renders unique the message payloads between the computer 10 and the network 22 can be shared between the stacks 18, 26.

Proceeding to block 38, the main processor 14 is powered down along with other computer components while the low power processor 24 is maintained energized to complete entry into the suspend mode. At block 40, while in the suspend mode, keepalive packets are transmitted to the network 22 using the low power processor 24 and low power network stack 26.

While the particular MAINTAINING NETWORK LINK DURING SUSPEND STATE is herein shown and described in detail, it is to be understood that the subject matter which is encompassed by the present invention is limited only by the claims.

What is claimed is:

1. A portable computer, comprising:
a portable housing;
a main processor in the housing and configured to use a main network communication stack to communicate with a network in a normal operating mode; and
a low power processor in the housing and configured to use a low power network communication stack to communicate with the network in a suspend mode.

2. The computer of claim 1, wherein network communication is controlled by the main processor using the main network communication stack in the normal operating mode, network communication being controlled by the low power processor using the low power network communication stack in the suspend mode.

3. The computer of claim 1, wherein information is exchanged between the stacks prior to deenergizing the main processor.

4. The computer of claim 3, wherein the information exchanged between the stacks includes information needed to send keepalive packets to the network to maintain a network connection.

5. The computer of claim 3, wherein the information exchanged between the stacks includes information that renders unique message payloads between the computer and the network.

6. The computer of claim 3, wherein the information is exchanged by means of storing the information in a location accessible to both processors.

7. The computer of claim 3, wherein the information is exchanged by means of giving at least one processor capability to read the stack of the other processor.

8. The computer of claim 3, wherein information is exchanged between stacks in response to a change of network communication state.

9. The computer of claim 3, wherein the information includes at least one secret key and at least rolling header information.

10. Computer, comprising:
main processor with associated main network communication protocol stack configured to communicate with a network; and
low power processor with associated low power network communication protocol stack configured to communicate with the network.

11. The computer of claim 10, wherein both processors are contained in a single portable housing and information required to maintain a connection with the network is available to both processors.

12. The computer of claim 11, wherein the information includes information needed to send keepalive packets to the network to maintain a network connection.

13. The computer of claim 11, wherein the information includes information that renders unique message payloads between the computer and the network.

14. The computer of claim 11, wherein the information is exchanged by means of storing the information in a location accessible to both processors.

15. The computer of claim 11, wherein the information is exchanged by means of giving at least one processor capability to read the stack of the other processor.

16. The computer of claim 11, wherein information is exchanged between stacks in response to a change of network communication state.

17. The computer of claim 11, wherein the information includes at least one secret key and at least rolling header information.

18. Method, comprising:
maintaining a low power processor in a computer energized in a suspend state;
deenergizing a main processor of the computer in the suspend state; and
using the low power processor to maintain a network connection by sending keepalive packets as required by a network communication protocol.

19. The method of claim 18, comprising making available to the low power processor information needed to send keepalive packets to a network to maintain the network connection.

20. The method of claim 18, wherein the information includes at least one secret key and at least rolling header information.
